(19) United States
(12) Patent Application Publication
(10) Pub. No.: US 2023/0003536 A1
(43) Pub. Date: Jan. 5, 2023

(54) VEHICLE TRANSIT ON DEMAND

(71) Applicant: Toyota Motor Engineering & Manufacturing North America, Inc., Plano, TX (US)

(72) Inventor: Masashi Nakagawa, Sunnyvale, CA (US)

(21) Appl. No.: 17/366,746

(22) Filed: Jul. 2, 2021

(51) Int. Cl. G01C 21/34; B60L 58/12; G05D 1/02; B60L 53/14; G06Q 30/02

(52) U.S. Cl. CPC G01C 21/3469; B60L 58/12; G05D 1/0212; B60L 53/14; G06Q 30/0283

(57) ABSTRACT

A system for managing sharing of electric vehicles includes a network access device configured to: receive available vehicle information for a plurality of available vehicles including an available vehicle location of each of the available vehicles and an available vehicle SOC of each vehicle, and receive a vehicle swap event from a first source including at least one of a current vehicle or a mobile device, the vehicle swap event corresponding to a request for the user of the first vehicle to operate another vehicle. The system further includes a processor coupled to the network access device and configured to: select a selected available vehicle from the available vehicles based on the available vehicle location and the available vehicle SOC in response to the vehicle swap event, and control the network access device to transmit information corresponding to the selected available vehicle to the current vehicle.

### BACKGROUND

### 1. Field

The present disclosure relates to systems and methods for managing temporary vehicle swapping to allow drivers to reach destinations using multiple vehicles to avoid stops for charging an initial vehicle.

### 2. Description of the Related Art

Electric vehicles are becoming more ubiquitous on the roads. These vehicles may provide significant advantages over conventional gas engine vehicles such as reduced emissions, increased acceleration, and the like. Some electric vehicles include an additional source of electricity such as a gas engine and a generator to convert power from the gas engine into electricity, or a fuel cell stack that converts hydrogen and oxygen into electricity. Vehicles without this additional energy source have a disadvantage in that their range is limited by the capacity of the on-board battery.

Advances are being made in charging technology to increase charging rate. Likewise, more electric charging stations are being installed daily. However, the amount of time for a typical recharge may be relatively great, and there still exists a relatively large swath of land that is without electric charging stations. In that regard, it is desirable to determine ways to enlarge a driving range.

Thus, there is a need in the art for enlarging a driving range that is reachable by various vehicle users.

### SUMMARY

Described herein is a system for managing sharing of electric vehicles. The system includes a network access device configured to: receive available vehicle information for a plurality of available vehicles including an available vehicle location of each of the available vehicles and an available vehicle state of charge (SOC) of each of the available vehicles, and receive a vehicle swap event from a first source including at least one of a current vehicle or a mobile device associated with a user of the first vehicle, the vehicle swap event corresponding to a request for the user of the first vehicle to operate another vehicle. The system further includes a processor coupled to the network access device and configured to: select a selected available vehicle from the available vehicles based on the available vehicle location and the available vehicle SOC in response to the vehicle swap event, and control the network access device to transmit information corresponding to the selected available vehicle to the current vehicle.

Also described is a system for managing sharing of electric vehicles. The system includes a main body. The system further includes a battery located in or on the main body, having a state of charge (SOC), and configured to store electrical energy usable to propel the main body. The system further includes a network access device configured to communicate with a remote server. The system further includes an electronic control unit (ECU) coupled to the battery and the network access device and configured to: determine a vehicle swap event corresponding to a request for a user of the main body to access another vehicle, and receive an available vehicle data from the remote server corresponding to an available vehicle for the user to access.

Also described is a method for managing sharing of electric vehicles. The method includes receiving, by a network access device, available vehicle information for a plurality of available vehicles and an available vehicle SOC of each of the available vehicles. The method further includes receiving, by the network access device, a vehicle swap event from a first source including at least one of a current vehicle or a mobile device associated with a user of the first vehicle, the vehicle swap event corresponding to a request for the user of the first vehicle to operate another vehicle. The method further includes selecting, by a processor, a selected available vehicle from the available vehicles based on the available vehicle location and the available vehicle SOC in response to the vehicle swap event. The method further includes controlling, by the processor, the network access device to transmit information corresponding to the selected available vehicle to the current vehicle.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a block diagram illustrating a system for swapping vehicles within a fleet according to an embodiment of the present invention;

FIG. 2 is a block diagram illustrating a vehicle and a system for swapping vehicles within a fleet according to an embodiment of the present invention;

FIGS. 3A and 3B are flowcharts illustrating a method for swapping vehicles within a fleet according to an embodiment of the present invention; and

FIGS. 4A and 4B are flowcharts illustrating a method for swapping vehicles within a fleet according to an embodiment of the present invention.

### DETAILED DESCRIPTION

The present disclosure describes systems and methods for swapping vehicles within a fleet. The systems provide various benefits and advantages such as providing users the opportunity to swap a current vehicle for a new vehicle that may have a greater state of charge (SOC). This advantageously significantly increases a range in which electric vehicle users can travel because each vehicle in the network may be drivable by the vehicle users. The systems further provide the advantage of allowing drivers to provide their vehicle preferences so that any borrowed vehicle matches their preferences. The systems advantageously allow for autonomous travel of vehicles such that a vehicle to be borrowed may autonomously drive to a location of a vehicle user, thus saving the user time and energy. The systems further provide the advantage of allowing a driver's information to be transferred automatically from their previous vehicle to their next vehicle.

An exemplary system includes a server having a processor and a memory. The memory may store vehicle information from multiple vehicles including a state of charge (SOC) of the vehicles, locations of the vehicles, or the like. The memory may also store preference data corresponding to preferences of users (such as vehicle type, desirable accessories, or the like). The processor may receive a vehicle swap request from a user corresponding to a request to swap a current vehicle for a new vehicle. The processor may then determine which vehicles are available for the user to drive. The processor may select and transmit information corresponding to one of the available vehicles as a selected available vehicle, such that the user may then borrow the selected available vehicle to increase a driving range.

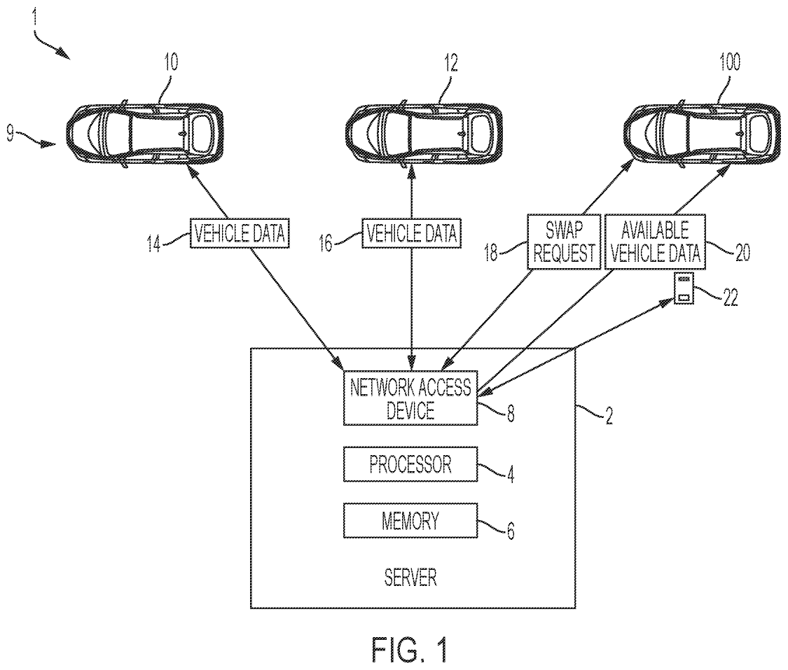

Referring now to FIG. 1, a system 1 for managing sharing of vehicle (e.g., swapping of a first, or requesting, vehicle with a second, or available, vehicle) is shown. The system 1 includes a server 2, a plurality of vehicles 9, and one or more mobile device 22. The server 2 includes a processor 4, a memory 6, and a network access device 8.

The server 2 may be a cloud server or a dedicated server, and may be hosted in a single location or may be distributed across multiple locations. The server 2 may include redundant capabilities to ensure continuous operation.

The processor 4 may include one or more logic devices such as one or more of a central processing unit (CPU), an accelerated processing unit (APU), a digital signal processor (DSP), a field programmable gate array (FPGA), an application specific integrated circuit (ASIC), or the like. The memory 6 may include any non-transitory memory 6 known in the art. The memory 6 may store instructions usable by the processor 4 to perform operations (i.e., may store specific program instructions for the processor 4 to perform the various actions described herein). The memory 6 may also or instead store other data as instructed by the processor 4 such as storing received vehicle data or vehicle locations received from the plurality of vehicles 9.

The network access device 8 may include any network access device capable of communicating via a wireless protocol. For example, the network access device 8 may communicate via Bluetooth, Wi-Fi, a cellular protocol, vehicle to vehicle (V2V) communications, Zigbee, or any other wireless protocol. The network access device 8 may communicate (i.e., transmit and/or receive data) with respective network access devices of the plurality of vehicles 9 and the mobile devices 22.

The vehicles 9 may include any vehicles which utilize electrical energy to generate propulsion. For example and as described in further detail below, the vehicles 9 may include a battery that stores electrical energy and a motor-generator that converts stored electrical energy into rotational power (i.e., torque).

The vehicles 9 may include, for example, a first vehicle 10, a second vehicle 12, and a third vehicle 100. Some or all of the vehicles 9 may transmit vehicle data to the server 2 via the network access device 8. For example, the first vehicle 10 may transmit first vehicle data 14 to the server 2 and the second vehicle may transmit second vehicle data 16 to the server 2. The first vehicle data 14 and the second vehicle data 16 may include, for example, a current location of the respective vehicle 9, a current state of charge (SOC) of a battery of the respective vehicle 9, whether the vehicle 9 is available to be driven, whether the respective vehicle 9 is a self-charging vehicle (e.g., whether it includes fuel cells or gas and a generator to generate electricity, or whether it is a pure electric vehicle), a model of the respective vehicle 9, available features within the respective vehicle 9, or the like. The vehicle data 14, 16 may further include account information associated with the respective vehicle such as corresponding to a charge account (which may include credit card or bank account information) or a loyalty account (which may include a quantity of loyalty points associated with the account). The vehicle data 14, 16 may also include preference data including a minimum SOC to which the owner of the respective vehicle 9 is willing for the respective vehicle 9 to be depleted. The preference data may also include a cost to use the respective vehicle 9 or a range of dates or times during which the respective vehicle 9 is available to be used. The preference data may also include a geographical area in which the respective vehicle 9 is willing to be driven in.

From time to time, a user of one of the vehicles 9 may realize its SOC is less than a desired amount such that the vehicle is incapable of reaching a destination without being charged. In that regard, the user may request use of any other vehicles 9 associated with the system 1 (or even vehicles unassociated with the system 1) while the user's vehicle is being charged. For example, the vehicle 100 may transmit a swap request 18 to the server 2. The swap request 18 may include various information such as a current SOC of the vehicle 100, a destination of the vehicle user, a current location of the vehicle 100, a price that an owner of the vehicle 100 is willing to pay for use of another vehicle, a current range of the vehicle 100, a geographical area in which the vehicle 100 is willing to remain, a direction of travel of the vehicle 100, or the like.

The server 2 may receive the swap request 18 and may select one or more of the remaining vehicles 9 as available vehicles that meet the criteria of the swap request 18. For example, if the swap request 18 requests 3 hours of use then the server 2 may select any of the vehicles 9 that are available during that time period and have at least enough energy to remain driving for the three hours as available vehicles. In some embodiments, the server 2 may select an optimal available vehicle and may transmit available vehicle data corresponding to the optimal available vehicle to the vehicle 100. In some embodiments, the server 2 may select multiple available vehicles and may transmit available vehicle data 20 corresponding to each of the multiple available vehicles to the vehicle 100. In some embodiments, the vehicle 100 (or a user of the vehicle 100) may select a selected available vehicle based on the available vehicle data 20 and may transmit the selected available vehicle to the server 2.

The server 2 may then transmit additional available vehicle data 20 to the vehicle 100 (or a mobile device 22 associated with a user of the vehicle 100) which may include a current location of the selected vehicle, digital key information corresponding to the selected vehicle, navigation instructions to the selected vehicle, or the like. In some embodiments, the vehicle 100 may be autonomous and therefore capable of autonomously traveling to the location of the selected vehicle.

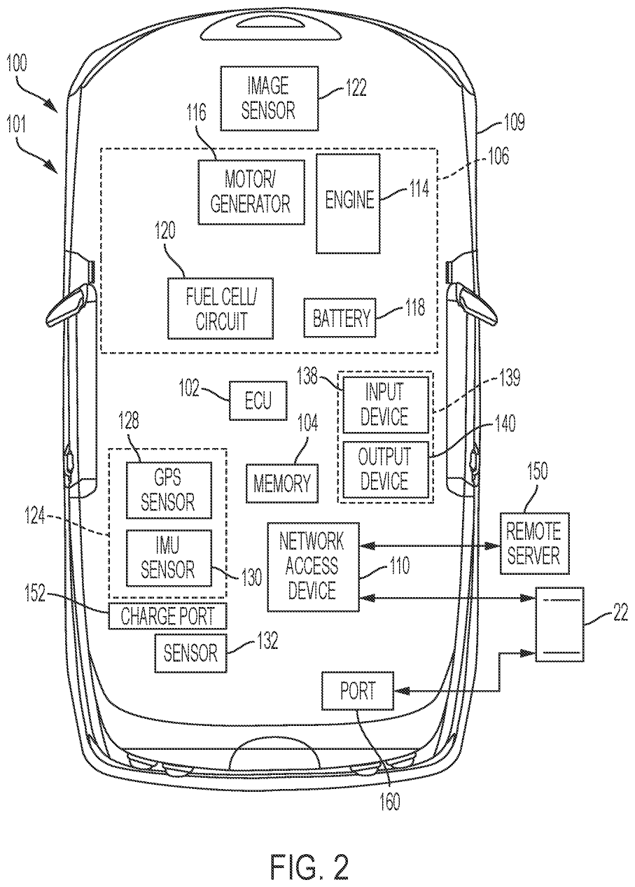

Turning to FIG. 2, additional details of the vehicle 100 are shown. The vehicle 100 may include a system 101 for facilitating sharing of vehicles by users. The vehicle 100 (or system 101) may include an ECU 102, a memory 104, a power source 106, and a main body 109. The vehicle 100 (or system 101) may further include a network access device 110, an image sensor 122, a location sensor 124, and a sensor 132. The vehicle 100 may also include an input device 138 and an output device 140, which together may be referred to as the IVI interface 139. The vehicle 100 may further include a charge port 152 and a port 160.

The main body 109 may be propelled along a roadway, may be suspended in or on water, or may fly through air. The main body 109 may resemble a vehicle such as a car, a bus, a motorcycle, a boat, an aircraft, or the like. The main body 109 may further support one or more individual such as a driver, a passenger, or the like. The main body 109 may define or include a vehicle cabin 111 in which a driver, passengers, or the like may be located.

The ECU 102 may be coupled to each of the components of the vehicle 100 and may include one or more processors or controllers which may be specifically designed for automotive systems. The functions of the ECU 102 may be implemented in a single ECU or in multiple ECUs. For example, the ECU 102 may include a power source ECU that controls the power source 106, an IVI ECU that controls the IVI interface 139, or the like. The ECU 102 may receive data from components of the vehicle 100, may make determinations based on the received data, and may control the operations of the components based on the determinations.

The vehicle 100 may be non-autonomous, fully autonomous, or semi-autonomous. In that regard, the ECU 102 may control various aspects of the vehicle 100 (such as steering, braking, accelerating, or the like) to maneuver the vehicle 100 from a starting location to a destination location. In some embodiments, the vehicle 100 may be operated in an autonomous, semi-autonomous, or fully driver-operated state. In that regard, the vehicle 100 may be operated independently of driver control and, from time to time, without a person inside of the vehicle 100. The ECU 102 may facilitate such autonomous functionality. The ECU 102 may also, for example, control charging of the vehicle 100 via the charge port 152.

The memory 104 may include any non-transitory memory and may store data usable by the ECU 102. The memory 104 may be located in or on the main body 109 and may thus be referred to as a local memory. In some embodiments, the memory 104 may be located remote from the main body 109 and may thus be a remote memory (i.e., memory that is accessed from the cloud via the network access device 110).

The power source 106 may include any one or more of an engine 114, a motor-generator 116, a battery 118, and a fuel cell circuit 120. The engine 114 may convert a fuel into mechanical power for propelling the vehicle 100. In that regard, the engine 114 may be a gasoline engine, a diesel engine, an ethanol engine, or the like.

The battery 118 may store electrical energy. In some embodiments, the battery 118 may include any one or more energy storage devices including a battery, a flywheel, a super capacitor, a thermal storage device, or the like. The battery 118 may be used to store power usable by the motor generator 116, power usable to start the engine 114, or the like.

The fuel-cell circuit 120 may include a plurality of fuel cells that facilitate a chemical reaction to generate electrical energy. For example, the fuel cells may receive hydrogen and oxygen, facilitate a reaction between the hydrogen and the oxygen, and output electricity in response to the reaction. In that regard, the electrical energy generated by the fuel-cell circuit 120 may be stored in the battery 118 and/or used by the motor-generator 116 or other electrical components of the vehicle 100. In some embodiments, the vehicle 100 may include multiple fuel-cell circuits including the fuel-cell circuit 120.

The motor-generator 116 may convert the electrical energy stored in the battery 118 (or electrical energy received directly from the fuel-cell circuit 120) into mechanical power usable to propel the vehicle 100. The motor-generator 116 may further convert mechanical power received from the engine 114 or from wheels of the vehicle 100 into electricity, which may be stored in the battery 118 as energy and/or used by other components of the vehicle 100. In some embodiments, the motor-generator 116 may include a motor without a generator portion and, in some embodiments, a separate generator may be provided.

The location sensor 124 may include any sensor capable of detecting data corresponding to a current location of the vehicle 100. For example, the location sensor 124 may include one or more of a global positioning system (GPS) sensor 128, an inertial measurement unit (IMU) sensor 130, or the like. The GPS sensor 128 may detect data corresponding to a location of the vehicle. For example, the GPS sensor 128 may detect global positioning coordinates of the vehicle 100. The IMU sensor 130 may include one or more of an accelerometer, a gyroscope, or the like. The IMU sensor 130 may detect inertial measurement data corresponding to a position, a velocity, an orientation, an acceleration, or the like of the vehicle 100. The inertial measurement data may be used to identify a change in location of the vehicle 100, which the ECU 102 may track in order to determine a current location of the vehicle 100.

The image sensor 122 may be coupled to the main body 109 and may detect image data corresponding to an environment of the vehicle 100, data corresponding to the vehicle cabin 111, or the like. For example, the image sensor 122 may include a camera, a radar detector, a lidar detector, or any other image sensor capable of detecting light having any wavelength. The image sensor 122 may include one or multiple image sensors which may be oriented to detect image data in any direction relative to the main body 109 (and/or within the vehicle cabin 111). For example, the image sensor 122 may include four or more radar detectors to detect radar data on all four sides of the main body 109. The image sensor 122 may also or instead include a first camera to detect image data in a forward direction relative to the main body 109 and a second camera to detect image data in a rear direction relative to the main body 109.

The sensor 132 may include one or more of a sensor capable of detecting a status of a vehicle component, a sensor capable of detecting environmental conditions (including weather), or the like. For example, the sensor 132 may include a voltage sensor, a current sensor, a temperature sensor, a pressure sensor, a fuel gauge, an airflow sensor, an oxygen sensor, or the like. In that regard, the sensor 132 may detect data corresponding to the SOC of the battery 118, and the ECU 102 may calculate the SOC based on the detected data.

The input device 138 may include any one or more input device such as a button, a keyboard, a mouse, a touchscreen, a microphone, or the like. The input device 138 may receive input from a user of the vehicle 100 such as a driver or a passenger. The input device 138 may receive, for example, a desired destination for the vehicle 100, a calendar of the user, a desired SOC for the battery 118, or the like. The input device 138 may also receive information corresponding to an availability of the vehicle 100 to be used to charge other vehicles, a minimum allowable SOC of the battery 118, or the like.

The output device 140 may include any output device such as a speaker, a display, a touchscreen, or the like. The output device 140 may output data to a user of the vehicle. The output device 140 may, for example, output audio data indicating a current range of the vehicle 100, a current SOC of the battery 118, a remaining time to reach an available vehicle, or the like.

The network access device 110 may include any network access device capable of communicating via a wireless protocol. For example, the network access device 110 may communicate via Bluetooth, Wi-Fi, a cellular protocol, vehicle to vehicle (V2V) communications, Zigbee, or any other wireless protocol. The network access device 110 may be referred to as a data communication module (DCM) and may communicate with any device on the vehicle 100 and/or any remote device. For example, the network access device 110 may communicate with the server 2 of FIG. 1, the mobile device 22, or the like.

The charge port 152 may receive electrical energy from a source external to the vehicle 100. For example, the charge port 152 may receive electrical energy from an electric charger or from a cable or other contact that is coupled to another vehicle (e.g., the vehicle 10 or 12 from FIG. 1).

The port 160 may include any wired or wireless port capable of communicating with an electronic device such as the mobile device 22. The port may, for example, receive digital key information from the mobile device 22 via a near-field communication (NFC) or other protocol. The port 160 may, in some embodiments, be considered part of the network access device 110.

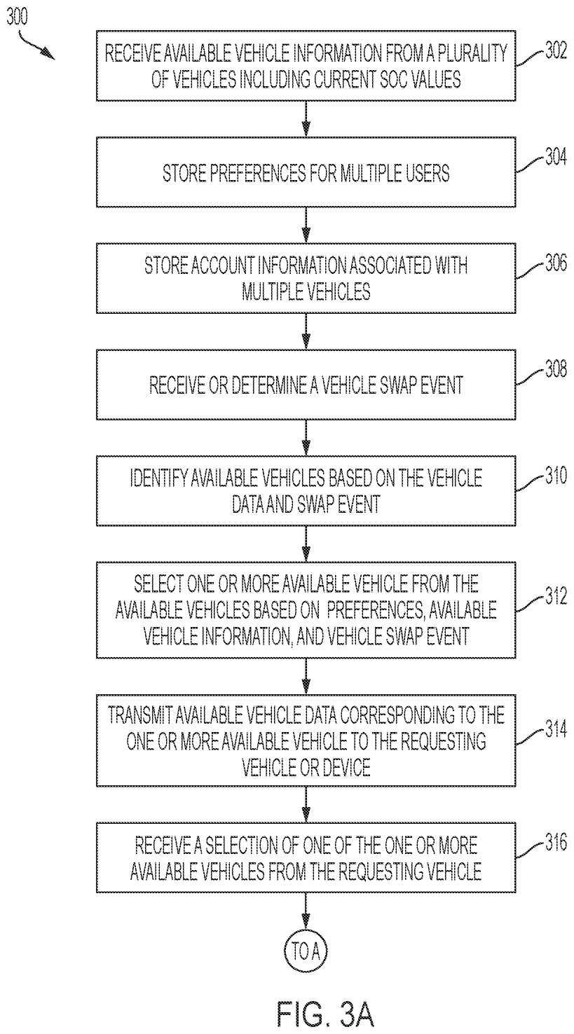

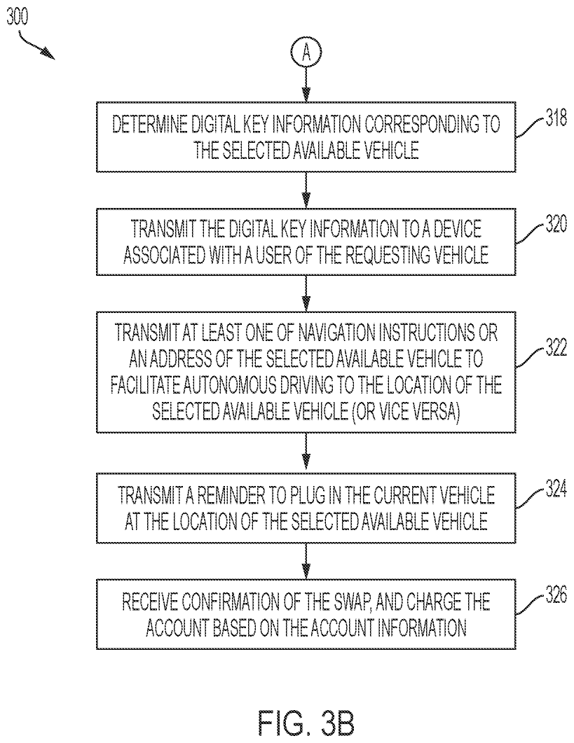

Referring now to FIGS. 3A and 3B, a method 300 for managing sharing of electrical vehicles is shown. The method 300 may be used by a server to manage a fleet (e.g., a rental fleet, a fleet owned by a dealership, a fleet managed by a government or private entity, a fleet available for members, or the like). Multiple users may be members of an organization that is associated with the fleet, and the method 300 may facilitate sharing of the vehicles of the fleet. For example, users or members of the organization may realize that a current vehicle lacks sufficient charge to reach a destination, and may request a vehicle swap using a mobile device or via an input device of the current vehicle. The method 300 may be used to file an available vehicle which the user may drive that will allow him to reach the destination without having to recharge.

The method 300 may begin in block 302 in which a server may receive available vehicle information from a plurality of vehicles. The available vehicle information may include any of multiple types of information such as a current SOC of each respective vehicle, a current range of each vehicle, a model or vehicle type of each vehicle, a current location of each vehicle, features of the vehicle, time periods in which the vehicle is available for use, a cost per unit of time to use the vehicle (e.g., if the owner of the vehicle is to be paid for its use), or the like.

In block 304, the server may store, in a memory, preferences for each of multiple users. The preferences may be received from the users (e.g., via input provided by a mobile device or by an input device of a vehicle) or may be learned (e.g., the server may learn preferences of each user as they interact with the system; for example, if the user always requests an SUV from the available vehicles then the server may learn that a preference is to drive SUVs). The preferences may include, for example, vehicle types or models, an amount of time that the driver prefers to drive without stopping to recharge the vehicle, whether the user prefers to pay more money to use higher end vehicles, features that the driver prefers (e.g., touchscreen navigation or Bluetooth-compatible entertainment systems), or the like.

In block 306, the server may store account information associated with multiple vehicles. For example, the account information may include bank account and routing numbers, credit card numbers, usernames, or the like for drivers or owners of the vehicles in the fleet. This account information may be used as credit information (e.g., to pay for use of another vehicle) or debit information (e.g., to compensate owners of the vehicles for use of their vehicles).

In block 308, the server may receive or determine a vehicle swap event. For example, a user of a vehicle in the fleet may transmit a vehicle swap request via an input device of a current vehicle or via a mobile device associated with the user. In some embodiments, the server may determine the vehicle swap event. For example, the server may learn that a current vehicle of a user has insufficient charge to reach a destination, and the server may determine a vehicle swap event in response to making this determination. The vehicle swap event may correspond to a request or instruction for a user of the system to borrow or otherwise use another vehicle in the fleet.

The vehicle swap event may include, for example, a current location of a current vehicle (or of the user), a destination of the user, a current SOC of the current vehicle, a schedule of the user, user preferences, or the like.

In block 310, the server may identify available vehicles as vehicles that are available for use by the user and are within a current range of the current vehicle. In some embodiments, the server may only select available vehicles as vehicles that are on a current route of the current vehicle, that meet predetermined body type preferences, or that are available for an entire duration of a trip of the user.

In block 312, the server may select one or more available vehicles from the plurality of available vehicles based on the vehicle data received or stored in block 302, based on the preferences of the requesting user in block 304, and based on the vehicle swap event in block 308. In some embodiments, the server may identify only one optimal available vehicle that best meets the preferences of the requesting user and meets the vehicle swap event (e.g., that is within a current range of the current vehicle and preferably is on a route from a current location of the current vehicle to a destination). In some embodiments, the server may identify multiple available vehicles that meet at least some preferences of the requesting user and the swap event. In some embodiments, the server may be programmed to store, or to learn, an importance of each user preference (e.g., the server may learn that reducing trip time is the most important factor for a user, or that inclusion of a high-quality sound system is the most important factor). The server may or may not rank the available vehicles based on how well each meets the preferences and the swap event.

In block 314, the server may transmit available vehicle data corresponding to the one or more available vehicle to the current vehicle or device. The available vehicle data may include relatively little information or may include a significantly larger quantity of information. For example, the available vehicle data may include any of the vehicle data from block 302 such as current location of the available vehicle(s), an SOC of the available vehicle(s), a date and/or time that the available vehicle is available for use, or the like.

As server above, the processor may transmit available vehicle data corresponding to multiple available vehicles to the current vehicle (or other device associated with the current vehicle). In that regard, an output device of the current vehicle (or a mobile device associated with the current vehicle) may output the available vehicle information such that a user of the current vehicle may review the available vehicle information. In block 316 and after reviewing the available vehicle information, an input device of the current vehicle (or mobile device) may receive a selection of one of the available vehicles, and this selection may be provided to the server. This selected vehicle may be referred to as the selected available vehicle. In some embodiments, the server may select a single selected available vehicle such that block 316 is unnecessary. The single, resulting available vehicle that is driven by the user may be referred to as a new driving vehicle.

In block 318, the server may determine digital key information corresponding to the new driving vehicle. The digital key information may be stored in the memory of the new driving vehicle (i.e., as part of the vehicle data) or may be generated for a single use. For example, once an available vehicle is selected as the new driving vehicle, the server may generate a single-use digital key that the user may use to drive the new driving vehicle. In some embodiments, the new driving vehicle may travel to a location of the current vehicle or the user (i.e., the new driving vehicle may be an autonomous vehicle and may receive a destination address or navigation instructions from the server).

In block 320, the server may transmit the determined digital key information to the current vehicle or to a mobile device associated with a user of the current vehicle. As referenced above, the digital key information may include a digital key that allows access to the charging vehicle (or to a portion of the charging vehicle).

In block 322, the server may transmit at least one of navigation instructions or an address of the selected available (i.e., the new driving) vehicle to the current vehicle or to the mobile device of the user. In some embodiments, the current vehicle may be an autonomous vehicle and may use the navigation instructions or address to autonomously drive the user to the location of the new driving vehicle. In some embodiments, the new driving vehicle and the current vehicle may both be autonomous, and may each drive to the location of the other (i.e., the new driving vehicle may travel to the current location of the current vehicle and vice versa) such that the user need not travel to the current location of the new driving vehicle. In some embodiments, the user may drive the current vehicle to the location of the new driving vehicle.

In block 324, the server may transmit a reminder to charge the current vehicle at the location of the selected available vehicle. This reminder may be transmitted to the current vehicle or to the mobile device of the user. In this way, the current vehicle may be at least partially recharged when the user retrieves it (if it belongs to the user) or at least partially recharged such that another user of the fleet may drive it.

In block 326, the server may receive confirmation of the vehicle swap. For example, at least one of the current vehicle or the new driving vehicle may transmit a notification to the server that the swap has been completed. As another example, the user may provide input via one of the vehicles or via a mobile device indicating that he has taken control of the new driving vehicle. As yet another example, the new driving vehicle may transmit a notification to the server in response to the digital key being used at the new driving vehicle, thus indicating that the swap is complete.

In some embodiments, information related to the driver may be automatically transferred from the current vehicle to the new driving vehicle. The transfer may be directly between the current vehicle and the new driving vehicle via known wireless communication protocols in the art or via the server. By example and not limitation, the information may include destinations, routes, points of interests, personal settings (e.g., seat adjustment, climate settings, mobile phone settings, etc.), music data, access keys (e.g., garage door, gate, etc.), and a toll collection identifier.

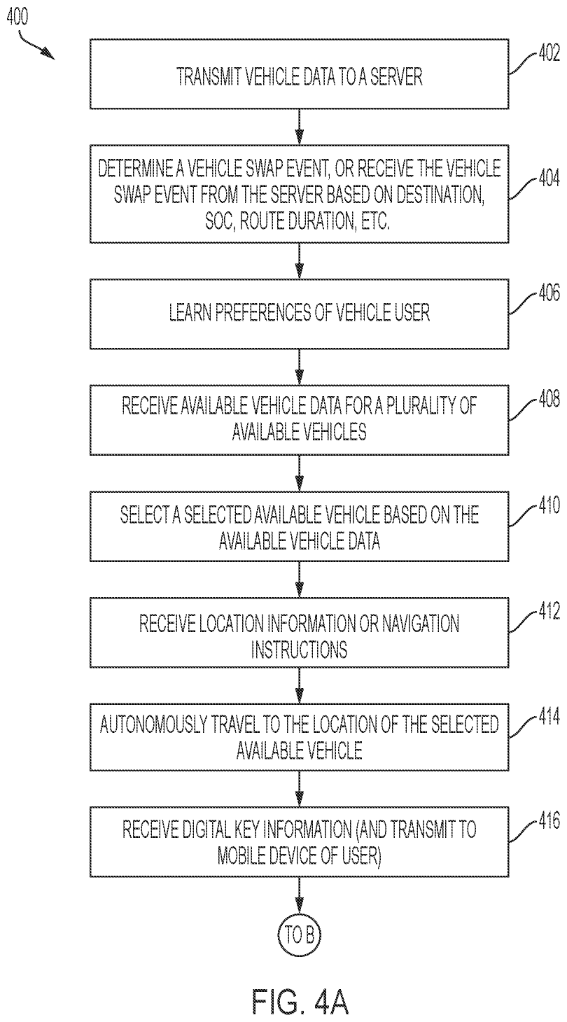

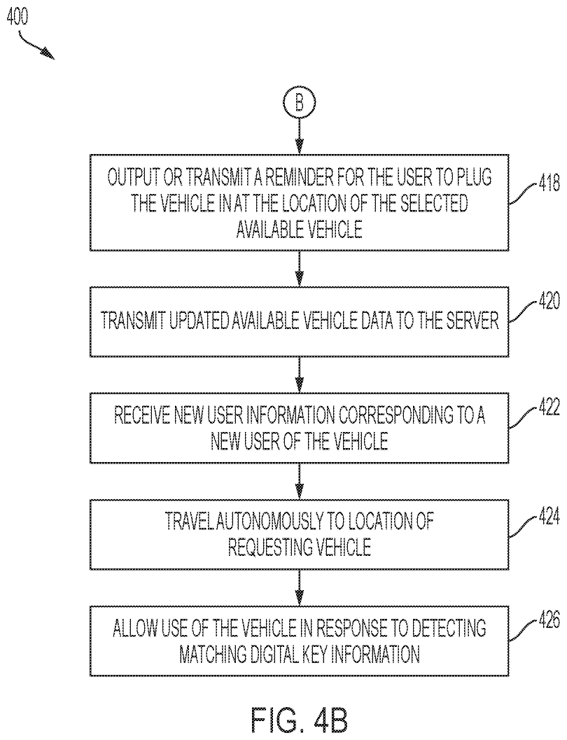

Referring now to FIGS. 4A and 4B, a method 400 for managing sharing of electrical vehicles is shown. The method 400 may be performed by one or more vehicles within a fleet. The method 400 may be used in conjunction with a server utilizing a method similar to the method 300 of FIGS. 3A and 3B.

In block 402, a vehicle may transmit vehicle data to a server. The vehicle data may include any of the vehicle data discussed herein, such as the vehicle information from block 302 of FIGS. 3A and 3B.

In block 404, the ECU of the vehicle may determine a vehicle swap event. The ECU may determine the vehicle swap event based on any of a number of criteria. For example, the ECU may determine a vehicle swap event in response to a current range of the current vehicle being less than a total distance from a current location to a destination. The ECU may also predict a current or future destination and determine a vehicle swap event if the vehicle includes insufficient SOC to reach the predicted destination. In some embodiments, the ECU may likewise predict an amount of time spent at each stop and predict or determine whether a vehicle charger is available at each destination. The ECU may take the potential charging opportunities into consideration when determining the vehicle swap event.

In some embodiments, the server may determine the vehicle swap event for the vehicle. The server may determine the vehicle swap event based on the same or similar considerations as the ECU uses in its prediction. In that regard, the vehicle may transmit information to the server such as a destination (or the server may predict the destination) and a current SOC, and the server may determine the vehicle swap event based on an analysis of this information.

In block 406, the ECU of the vehicle may learn preferences of a vehicle user. For example, the preferences may be similar to the preferences of block 304 of FIGS. 3A and 3B. In some embodiments, the ECU may transmit the learned preferences to the server and, in some embodiments, the ECU may store the learned preferences in a local memory on the vehicle.

In block 408, the ECU may receive available vehicle data for a plurality of available vehicles. The server may transmit the available vehicle data to the vehicle in response to receiving the vehicle swap event. That is, the ECU may transmit the vehicle swap event to the server (or the server may determine the vehicle swap event), the server may then determine available vehicles that meet the swap event and the driver preferences, and the server may transmit the available vehicle data to the current vehicle. In some embodiments, the server may only select a single available vehicle that best matches the preferences and vehicle swap event and, in some embodiments, the server may select multiple available vehicles.

In block 410, the ECU may select a selected available vehicle based on the received available vehicle data. For example, the server may transmit all available vehicles to the ECU that match the swap request (e.g., it may transmit information corresponding to each available vehicle within a current range of the current vehicle). The ECU may then analyze the available vehicle data and the learned user preferences and may select an available vehicle that best matches the user preferences. In some embodiments, the ECU may control an output device to output the available vehicle data such that the vehicle user may select a preferred available vehicle.

In block 412, the ECU may receive location information corresponding to the location of the selected available vehicle and, in some embodiments, the ECU may receive navigation instructions from its current location to the location of the selected available vehicle.

In block 414, the ECU may control the current vehicle to autonomously travel to the location of the selected available vehicle. For example, the ECU may determine a route from a current location to the location of the selected available vehicle and may autonomously control various aspects of the vehicle to travel to the location of the selected available vehicle.

In block 416, the ECU or a mobile device associated with a user of the current vehicle may receive digital key information. The digital key information may be usable to access and operate the selected available vehicle. In some embodiments, the server may generate a temporary digital key that is transmitted to the vehicle or mobile device that is operable for a period of time. In some embodiments, the server may transmit a digital key that is always usable to operate the selected available vehicle. In embodiments in which the vehicle receives the digital key information, the ECU may transmit the digital key information to a mobile device associated with the vehicle user such that the vehicle user may operate the selected available vehicle.

In block 418, the current vehicle may output a reminder for the user to plug in the current vehicle at the location of the selected available vehicle. This reminder may be output via an output device of the current vehicle, or may be transmitted to the mobile device associated with the user. Because the current vehicle may have a relatively low SOC, it may be desirable for the current vehicle to be recharged such that it is available for the user (or for another user) to use. The reminder may be transmitted or output prior to, or in response to, the current vehicle reaching the location of the selected available vehicle. In some embodiments, the reminder may include instructions for charging the current vehicle.

In block 420, the vehicle may transmit updated available vehicle data to the server. The updated available vehicle data may include any of the available vehicle data described herein. The data may be updated as the SOC of the vehicle increases and may include the current location of the current vehicle.

In block 422, the ECU may receive new user information corresponding to a new user of the vehicle. For example, the user may have submitted a vehicle swap request to the server, and the server (or current vehicle of the user) may select the present vehicle as the selected available vehicle. In that regard, the server may transmit digital key information to the user such that the user may operate the present vehicle.

In some embodiments and in block 424, the server may provide a location of the user to the present vehicle. In that regard, the present vehicle may be capable of autonomously driving itself to the location of the user, and may autonomously travel to the location of the user or the requesting vehicle.

In block 426, the present vehicle may allow the user to drive or otherwise control it in response to receiving or detecting digital key information from a device associated with the user.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for managing sharing of electric vehicles, the system comprising:
a network access device configured to:
receive available vehicle information for a plurality of available vehicles including an available vehicle location of each of the available vehicles and an available vehicle state of charge (SOC) of each of the available vehicles, and
receive a vehicle swap event from a first source including at least one of a current vehicle or a mobile device associated with a user of the first vehicle, the vehicle swap event corresponding to a request for the user of the first vehicle to operate another vehicle; and
a processor coupled to the network access device and configured to:
select a selected available vehicle from the available vehicles based on the available vehicle location and the available vehicle SOC in response to the vehicle swap event, and
control the network access device to transmit information corresponding to the selected available vehicle to the current vehicle.

2. The system of claim 1 wherein the processor is further configured to:
select a plurality of potential available vehicles based on the available vehicle location and the available vehicle SOC;
transmit information corresponding to the plurality of potential available vehicles to the first source; and
receive a selection of the selected available vehicle from the first source.

3. The system of claim 1 wherein the vehicle swap event includes information indicating a current destination of the current vehicle, and the processor is further configured to select the selected available vehicle as the one of the available vehicles that results in at least one of less additional miles driven or less additional time for the user of the current vehicle to reach the current destination.

4. The system of claim 1 wherein the processor is further configured to select the available vehicle based on at least one of a model of each of the available vehicles, a current SOC of each of the available vehicles, a cost to use each of the available vehicles, or features within each of the available vehicles.

5. The system of claim 1 wherein the processor is further configured to:
determine digital key information corresponding to the selected available vehicle; and
transmit the digital key information to the mobile device associated with the user of the current vehicle to allow the mobile device to access the selected available vehicle.

6. The system of claim 1 wherein the information corresponding to the selected available vehicle includes an identifier of the selected available vehicle and a location of the selected available vehicle.

7. The system of claim 1 further comprising a memory configured to store account information including at least one of payment information corresponding to the user of the current vehicle or loyalty points corresponding to the user of the current vehicle, wherein the processor is further configured to collect payment for use of the selected available vehicle using the account information.

8. The system of claim 1 wherein the current vehicle is an autonomous vehicle, and the information corresponding to the selected available vehicle includes at least one of a location of the selected available vehicle or navigation instructions from a current location of the current vehicle to the location of the selected available vehicle such that the current vehicle can travel autonomously to the location of the selected available vehicle using the information corresponding to the selected available vehicle.

9. The system of claim 1 wherein the selected available vehicle is an autonomous vehicle, and the network access device is further configured to transmit at least one of a current location of the current vehicle or a meeting location to the selected available vehicle such that the selected available vehicle can travel autonomously to the current location or to the meeting location.

10. The system of claim 1 wherein the network access device is further configured to transmit a reminder to the first source that reminds the user of the current vehicle to plug in the current vehicle at the available vehicle location of the selected available vehicle to charge the current vehicle.

11. A system for managing sharing of electric vehicles, the system comprising:
a main body;
a battery located in or on the main body, having a state of charge (SOC), and configured to store electrical energy usable to propel the main body;
a network access device configured to communicate with a remote server; and
an electronic control unit (ECU) coupled to the battery and the network access device and configured to:
determine a vehicle swap event corresponding to a request for a user of the main body to access another vehicle, and
receive an available vehicle data from the remote server corresponding to an available vehicle for the user to access.

12. The system of claim 11 further comprising an output device configured to output data and a power source configured to propel the main body, wherein the ECU is further configured to at least one of:
control the output to device to output at least one of a current available vehicle location of the available vehicle or navigation instructions from a current location of the main body to the current available vehicle location; or
autonomously control the power source to maneuver to the current available vehicle location.

13. The system of claim 11 wherein the available vehicle data includes a plurality of available vehicles, and the ECU is further configured to:
determine a current route from a current location of the main body to a current destination of the main body;
identify at least two available vehicles from the plurality of available vehicles that each have a sufficient SOC to reach the current destination; and
select the available vehicle as the one of the at least two available vehicles that results in at least one of less additional miles driven or less additional time from the current location to the current destination.

14. The system of claim 11 wherein the available vehicle data includes a plurality of available vehicles, and the ECU is further configured to select the available vehicle from the plurality of available vehicles based on at least one of a model of each of the at least two available vehicles, a current SOC of each of the at least two available vehicles, a cost to use each of the at least two available vehicles, or features within each of the at least two available vehicles.

15. The system of claim 11 further comprising a digital key port configured to receive a key transmission from the mobile device corresponding to a digital key, wherein:
the ECU is configured to receive new digital key information from the remote server corresponding to a new user of the main body, and
the ECU is configured to allow operation of the main body in response to the digital key port receiving the key transmission corresponding to the new digital key information.

16. The system of claim 11 wherein the ECU is further configured to:
determine a current destination of the main body; and
determine the vehicle swap event based on a current SOC of the battery and a predicted SOC drain from the current location of the main body to the current destination of the main body.

17. The system of claim 11 wherein the ECU is further configured to determine the vehicle swap event in response to the SOC of the battery reaching or dropping below a predetermined SOC threshold.

18. The system of claim 11 wherein the ECU is further configured to transmit updated SOC information to the remote server as the battery is charged, and to receive new user information corresponding to a new user of the main body from the remote server.

19. A method for managing sharing of electric vehicles, the method comprising:
receiving, by a network access device, available vehicle information for a plurality of available vehicles and an available vehicle SOC of each of the available vehicles;
receiving, by the network access device, a vehicle swap event from a first source including at least one of a current vehicle or a mobile device associated with a user of the first vehicle, the vehicle swap event corresponding to a request for the user of the first vehicle to operate another vehicle;
selecting, by a processor, a selected available vehicle from the available vehicles based on the available vehicle location and the available vehicle SOC in response to the vehicle swap event; and
controlling, by the processor, the network access device to transmit information corresponding to the selected available vehicle to the current vehicle.

20. The method of claim 19 wherein the vehicle swap event includes information indicating a current destination of the current vehicle, and selecting the selected available vehicle is performed by selecting the selected available vehicle as the one of the available vehicles that results in at least one of less additional miles driven or less additional time for the user of the current vehicle to reach the current destination.
